(19) United States
(12) Patent Application Publication
(10) Pub. No.: US 2018/0193864 A1
(43) Pub. Date: Jul. 12, 2018

(54) ALARM SYSTEM, ASSEMBLY COMPRISING A SPRAYING DEVICE AND SUCH AN ALARM SYSTEM AND AIR SPRAYING PROCESS

(71) Applicant: Exel Industries, Epernay (FR)

(72) Inventors: Nicolas Plantard, Paris (FR); Nicolas Ferrere, Paris (FR)

(21) Appl. No.: 15/860,029

(22) Filed: Jan. 2, 2018

(30) Foreign Application Priority Data
Jan. 10, 2017 (FR) 1750211

(51) Int. Cl. B05B 12/12; G08B 21/18; B05B 5/03; B05B 12/00

(52) U.S. Cl. CPC B05B 12/122; G08B 21/182; B05B 12/124; B05B 12/002; B05B 5/032

(57) ABSTRACT

The invention relates to an alarm system, designed to send an alarm signal to a user equipped with a spraying device when the spraying distance is below a minimum value or above a maximum value, an alarm signal may also be sent when a perpendicularity flaw exists between a spraying axis of the device and a surface to be coated positioned across from the spraying device, the alarm system including means for measuring a spraying distance with a surface to be coated positioned across from the spraying device, wherein the alarm system may also include means for detecting a perpendicularity flaw between the spraying axis and the surface to be coated.

### CROSS REFERENCE TO RELATED APPLICATIONS

This application claims priority under 35 USC § 119 of French Patent Application No. 17 50211 filed on Jan. 10, 2017.

### FIELD OF THE INVENTION

The invention relates to an alarm system for a spraying device, in particular for a gun designed to be held by a user.

### BACKGROUND OF THE INVENTION

Manual guns with an actuating trigger are known in the field of manual spraying devices. When the painter actuates the trigger, an electronic system on board the gun verifies whether the gun is at an adequate distance from the object to be coated and if so, opens the paint valve. The problem with this type of gun is that the painter may suffer musculoskeletal disorders (MSD) due to repeatedly actuating the trigger.

To resolve these drawbacks, some guns are provided without triggers. This type of gun comprises a sensor measuring the spraying distance and a nozzle, the opening of which is selectively controlled by moving the needle. The distance sensor triggers the opening and closing of the needle automatically as a function of the distance between the gun and the part to be coated. To spray the coating product, the user then only needs to point the gun toward the part to be coated. One drawback, however, of this 100% automatic mode is that the gun may continue to spray uncontrollably. Indeed, if the painter sets the gun on the ground, for example near a wall, then the gun may turn itself on and spray product on the wall, which is of course not desirable. This type of gun is therefore not suitable for beginning painters.

Furthermore, inexperienced painters often find it difficult to hold the gun so as to preserve the perpendicularity between the spraying axis of the gun and the surface to be coated. This lack of perpendicularity causes a poor application of the product and finishing flaws (excess thicknesses, overflow, etc.). Some guns are equipped with means for measuring the spray angle relative to the surface of the object to be coated and a valve that automatically adjusts the flow rate of coating product based on the incline of the gun relative to the surface to be coated. When the gun is oriented so as to obtain an optimal spray angle, the flow rate is increased. Conversely, the flow rate is decreased if there is a perpendicularity flaw. Systematically, the flow rate is also adjusted as a function of several parameters, such as the surface condition, the temperature, the speed of the gun relative to the object, the geometry of the surface, etc.

It is thus difficult for a nonprofessional painter to determine the origin of a decrease in flow rate, and therefore to correct the holding of the gun accordingly.

Furthermore, some spray guns, which are commonly called AIRMIX (registered trademark) paint guns, comprise a spray air injection system. This system comprises air discharge holes and the high-pressure jets from these holes strike the jet of coating product at the nozzle outlet, so as to form a homogeneous spray atomized in the form of droplets. In this type of gun, the product injection system and the spray air injection system are opened sequentially when the user presses the trigger: the air injection system is activated first and the product injection system is activated second. This is therefore a double-acting trigger.

### SUMMARY OF THE DESCRIPTION

The invention proposes an alarm system to facilitate the use of a spraying device and therefore to make the device usable even by beginning painters.

To that end, the invention relates to an alarm system, designed to send an alarm system to a user equipped with a spraying device when the spraying distance is below a minimum value or above a maximum value and/or when a perpendicularity defect exists between a spraying axis of the device and a surface to be coated positioned across from the spraying device, the alarm system comprising at least one means for measuring a spraying distance with the surface to be coated positioned across from the spraying device and/or means for detecting a perpendicularity defect between the spraying axis and the surface to be coated.

Owing to the invention, the user of the device can be alerted when he is too close to or far from the object. He is thus not required to gauge his distance from the object to be coated and assess whether this distance complies with the manufacturer's recommendations. The user can also be alerted when he is not holding the device correctly, i.e., when a significant perpendicularity flaw exists between the spraying axis of the gun and the surface to be coated. Owing to this system, even amateur or beginning painters, who generally have trouble estimating the spraying distance and holding the spraying device correctly, can use the spraying device.

According to advantageous, but optional aspects of the invention, such an alarm system may include one or more of the following features, considered in any technically allowable combination:
The alarm system includes a visual element, for example including at least one LED, and/or a sound element and/or a vibrator.
The alarm system is off board relative to the spraying device.
The measuring means comprise at least one ultrasonic sensor or a movement sensor, such as an accelerometer.
The detection means comprising any one of the following elements: a three-dimensional gyroscope, or a two-dimensional gyroscope, or three ultrasonic sensors, or at least two inclinometers, or a one-dimensional gyroscope and an inclinometer, or a one-dimensional gyroscope and two ultrasonic sensors.
The alarm system comprises a computer, which is capable of receiving information from the measuring means and/or detection means and which is capable of triggering the emission of the alarm signal.

The invention also relates to an assembly comprising an alarm system as previously described and a spraying device, such as a manual gun, for example.

According to advantageous, but optional aspects of the invention, such assemblies may incorporate one or more of the following features, considered in any technically allowable combination:
The alarm system is on board the spraying device.
The spraying device comprises a speed sensor, such as an accelerometer, for estimating the speed at which the device is moved relative to an inertial frame of reference.
The assembly comprises another alarm system, configured to alert the user that he is moving the spraying device too quickly relative to a setpoint value.
The spraying device comprises a dead man system, configured to interrupt the spraying when the user is inactive or when the user releases the spraying device, the dead man system preferably comprising a pushbutton, the spraying being interrupted when the pushbutton is released. In other words, the spraying device is configured to spray only when the user exerts a particular action on the spraying device, which is different from that of pulling a trigger. Typically, such particular action may be to depress a button and/or to hold the spraying device into the hand.
The spraying device is configured to spray only when the spraying distance is between a minimum and maximum value and/or only when the angle between the spraying axis of the spraying device and the surface to be coated facing the spraying device is between a minimum and a maximum value.
The dead man system includes a gripping sensor capable of detecting when the spraying device is held by a user, such as a capacitive, optical or thermal sensor.
The gripper sensor is integrated in a gripper stick of the pistol.
The dead man system is capable of transmitting a signal to an electronic control unit of the closing system of a nozzle of the device. This signal is preferably of the binary type and then has two states: “0” when the device is not taken in hand and/or when the button is not depressed and “1” when the gripping sensor detects a grip of the device and/or when the button is depressed. Accordingly, the spraying device is configured to spray only when the signal is at the state <<1>>.
The assembly also comprises a system indicating the spraying distance, and/or a system indicating the orientation of the device relative to an inertial frame of reference, to allow a user to estimate the spraying distance relative to the minimum value and relative to the maximum value and/or to estimate the orientation of the device relative to a minimum degree of orientation and a maximum degree of orientation.
The indicator system is on board the spraying device or offboard relative to the spraying device, the indicator system for example comprising a screen, configured to be installed against a wall of a spraying booth.
The spraying device is a device not actuated by a trigger.
The spraying device comprises a means of communication with a computer system, capable of sending said computer system, instantaneously or on a deferred basis, information relative to the spraying, such as the spraying times.

The invention also relates to a pneumatic spraying method, implemented using a spraying device comprising a proximity sensor, capable of detecting the presence of an object in the detection field, a system for injecting a coating product and a system for injecting spray air. According to the invention, the method comprises the following automated steps, during which:

a) the air injection system opens when an object enters the detection field of the sensor,

b) the product injection system opens on a timer relative to the air injection system,

c) the product injection system closes when the object leaves the detection field of the sensor,

d) the air injection system closes on a timer relative to the product injection system.

The invention lastly relates to a pneumatic spraying method, implemented using a spraying device comprising two proximity sensors, positioned such that the detection field of one is at least partially contained in the detection field of the other, a system for injecting a coating product and a system for injecting spray air. According to the invention, the method comprises the following automated steps, during which:

a) the air injection system opens when an object enters the detection field of either one of the two sensors,

b) the product injection system opens when the object enters the detection field of the other sensor,

c) the product injection system closes when the object leaves the detection field of either one of the two sensors,

d) the air injection system closes when the object leaves the detection field of the other sensor.

Owing to this method, the air injection system is always open before the product injection system, which makes it possible to avoid the transitional phase during which the spraying is not completely stabilized.

Advantageously, the spraying device comprises a means for electrostatically charging the coating product, which is activated before or during step a) and which is deactivated during or after step d).

Preferably, the means for electrostatically charging the coating product is activated manually, for example during the maneuvering of a control element of the spraying device.

### BRIEF DESCRIPTION OF THE DRAWINGS

The invention and other advantages thereof will appear more clearly in light of the following description, provided solely as an example and done in reference to the appended drawings, in which:

FIG. 1 is a schematic view showing a user in the process of painting a door using a spraying device belonging to an assembly according to the invention;

FIG. 2 is an enlarged perspective view of the spraying device of FIG. 1;

FIG. 3 is a view along arrow III in FIG. 2, and

FIG. 4 is a partial elevation view of the spraying device, shown across from a warped surface to be coated.

### DETAILED DESCRIPTION

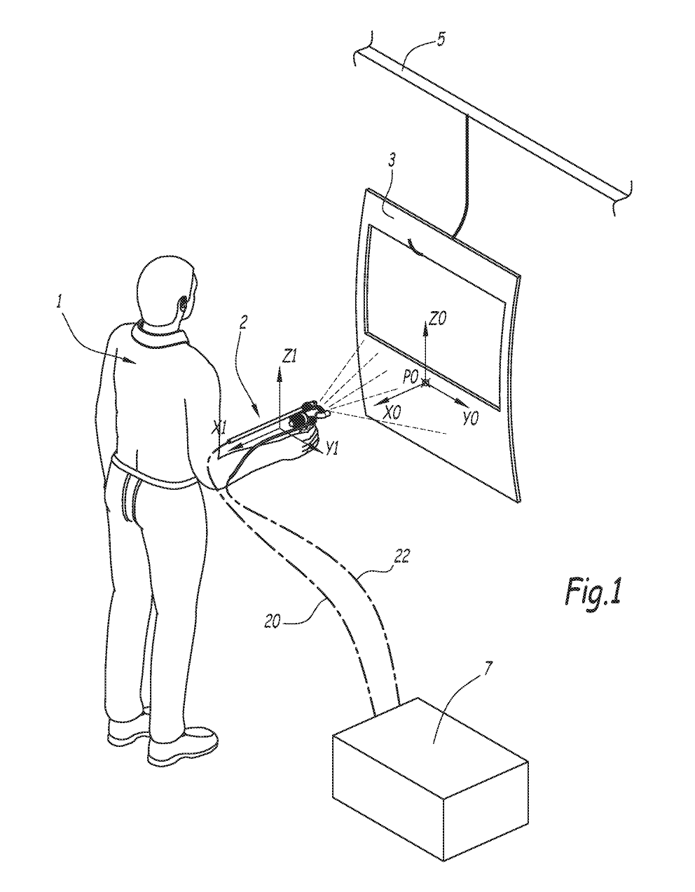

FIG. 1 shows an operator 1 in the process of spraying a coating product on a part 3 moved by a conveyor 5. To that end, the operator 1 uses a spraying device 2. The coating product may comprise one or several compounds. It may be in fluid or powdered form. It for example involves a paint, varnish, primer, lubricant, solvent, etc.

The spraying device 2 is supplied with coating product via a conduit 20 and with compressed air via two conduits 22, only one of which is shown in the figures. In the example, the conduits 20 and 22 are connected to a fixed supply housing 7. Alternatively, the supply housing 7 can be a mobile device, such as a carriage or a device placed on board by the user.

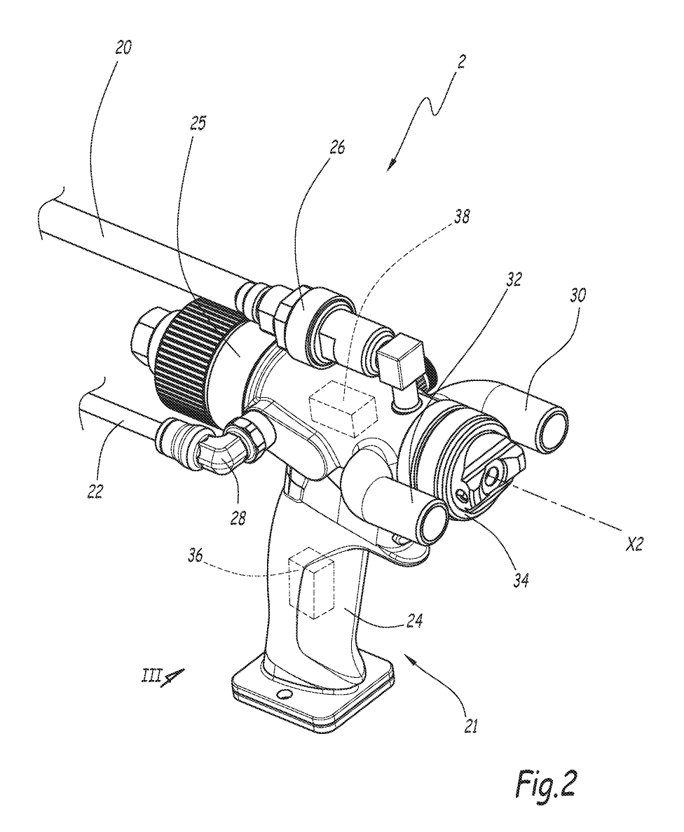

As shown in FIG. 2, the spray gun 2 comprises a gun 21. The gun 21 includes a gripping stock 24 to be gripped with the hand and a gun body 25 secured in the upper part of the stock 24. Advantageously, the body 25 of the gun comprises two bent couplers 28 to supply compressed air and one coupler 26 to supply coating product. A spray nozzle 34 is fastened on the body 25. This nozzle 34 defines a spraying axis X2 along which the product jet is sprayed under operating conditions.

Preferably, the spraying device 2 comprises at least one means for measuring the spraying distance, preferably several means for measuring the spraying distance. The spraying distance is the distance between the device 1 and the object to be coated 3, which is positioned across from the device 1, i.e., in the spraying field of the device 1. The spraying distance is measured parallel to the spraying axis X2.

In the example, the measuring means comprise an ultrasonic sensor 30, preferably two ultrasonic sensors 30 and 32. Each of the ultrasonic sensors 30 and 32 is mounted on the body 25 of the gun 21 and is configured to emit sound waves in a direction parallel to the spraying axis X2. The time with which the soundwave is reflected on the part is represented by the distance that separates the device from the part, i.e., the spraying distance.

The measuring means are connected to a computer (not shown) programmed to compare the distance values measured by the sensors 30 and 32 with a minimum value and a maximum value. The minimum value and the maximum value define a good distance range, in which the operator must be located during use of the device 2. The minimum and maximum values are prerecorded in a memory. They can be programmed by the user. Typically, the minimum value is greater than or equal to 10 cm, in particular equal to 15 cm, and the maximum value is less than or equal to 60 cm, in particular equal to 40 cm.

Advantageously, the spraying device 2 comprises an alarm system, designed to alert the operator 1 when the spraying distance is below a minimum value or above a maximum value. The alarm system is triggered by the computer, based on the result of the comparison of the spraying distance with the minimum value and the maximum value. In the embodiment of the figures, where two ultrasonic sensors are used to compute the distance, the distance with which the minimum value and the maximum value are compared is for example the average of the two distances d1 and d2, measured by the sensors 30 and 32. Alternatively, it may also involve the minimum distance or the maximum distance from among the distances d1 and d2.

In the example, the alarm system is on board the spraying device 2, i.e., integrated into the device. Preferably, the alarm system comprises a vibrator 36 (shown schematically) integrated into the stock 24. This vibrator 36 vibrates when the spraying distance is below the minimum value and when the spraying distance is above the maximum value, i.e., when the operator is not in the correct distance range.

Advantageously, the vibrator 36 can be configured to vibrate even more as the device 1 moves away from the correct distance range.

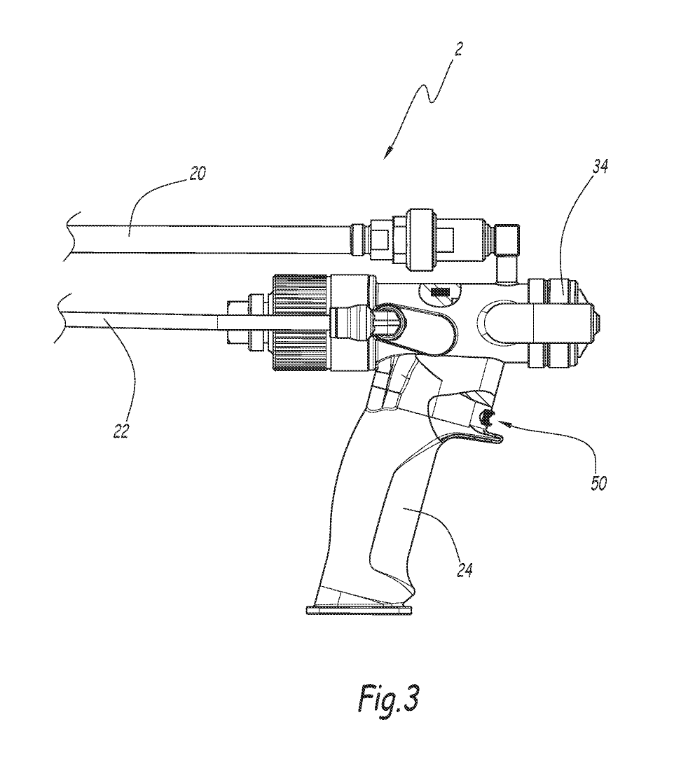

As shown in FIG. 3, the spraying device 2 advantageously comprises a dead man system, configured to interrupt spraying when the user is inactive.

In the example, the dead man system comprises a control element 50 that is a push button, arranged ergonomically in the upper part of the stock 24, near the index finger of the operator 1 when the latter grips the stock 24. By definition, a dead man system, also called “automatic standby”, is a system allowing the automatic triggering of an action if the operator stops moving or if a release by the operator occurs. In the example, if the operator 1 is in the process of spraying a coating product and releases the button 50, then the spraying is interrupted. Conversely, if the operator presses the button 50, then the product is sprayed.

Typically, the spraying device 1 comprises a moving needle (not shown) for closing the nozzle 34 and a closing system, configured to drive the movement of the needle between an open position and a closed position, and vice versa. The closing system may comprise an electromagnetic sucker, a solenoid electromagnet or a pneumatic solenoid valve that controls the arrival of the compressed air used to actuate the movement of the needle. A return spring can be provided to close the needle in case of electrical outage.

Advantageously, the spraying device 1 incorporates an electronic unit (not shown) for controlling the closing system. The electronic control unit is programmed to control the movement of the needle in the closed position when the control element 50 is not actuated. The embodiments shown in the figures therefore correspond to a 100% manual mode: the opening of the nozzle is controlled directly by the control element 50.

Preferably, the computer and the electronic control unit are in a single and same processor.

In the considered embodiment, the electronic control unit is connected to a sensor (not shown) associated with the button 50. This sensor is intended to detect the actuation and release of the button 50 and to send the information to the electronic unit. For example, the sensor can generate a binary-type signal, which assumes the value “1” when the button 50 is pushed in and the value “0” when the button 50 is released.

Advantageously, the spraying device 2 is a device without a trigger. In the field of coating product sprayers, an actuating trigger is an articulated part that is generally manipulated with the last four fingers of the hand to control the opening of the needle mechanically. Furthermore, a trigger makes it possible to adjust the sprayed product flow rate proportionally to the degree of actuation. The needle and the trigger are mechanically connected to one another. Conversely, in the invention, the button 50 is not mechanically connected to the needle, since the movement of the needle is controlled electronically. Furthermore, the button 50 does not allow the user to adjust the spraying flow rate. In other words, it is not a proportional effect button, but an ON/OFF button. With the element 50, the physical force that must be supplied by the operator to open the needle is much lower than that which must be provided with a trigger, such that the risk of the appearance of musculoskeletal disorders (MSD) after repeated use is limited.

Depending on another execution mode (not shown), spraying device 2 is voice-activated. In this case, the sprayer does not include a push button or other manual control element for activating the spraying. The activation and stopping of spraying is controlled by spoken instructions to be given orally. For example, sprayer 2 should preferably include a microphone to pick up any voice commands. Typically, typical instructions can be stored in memory, either in an internal memory of device 2 or on a networked hard disk with which the device can communicate. When the user issues instructions corresponding to those stored in memory, the device reacts by turning the spray on or off. For example, voice-activated instructions can be: “Activate spray” and “Stop spray”. Voice instructions could also be devised to increase the coating product flow and/or high voltage level.

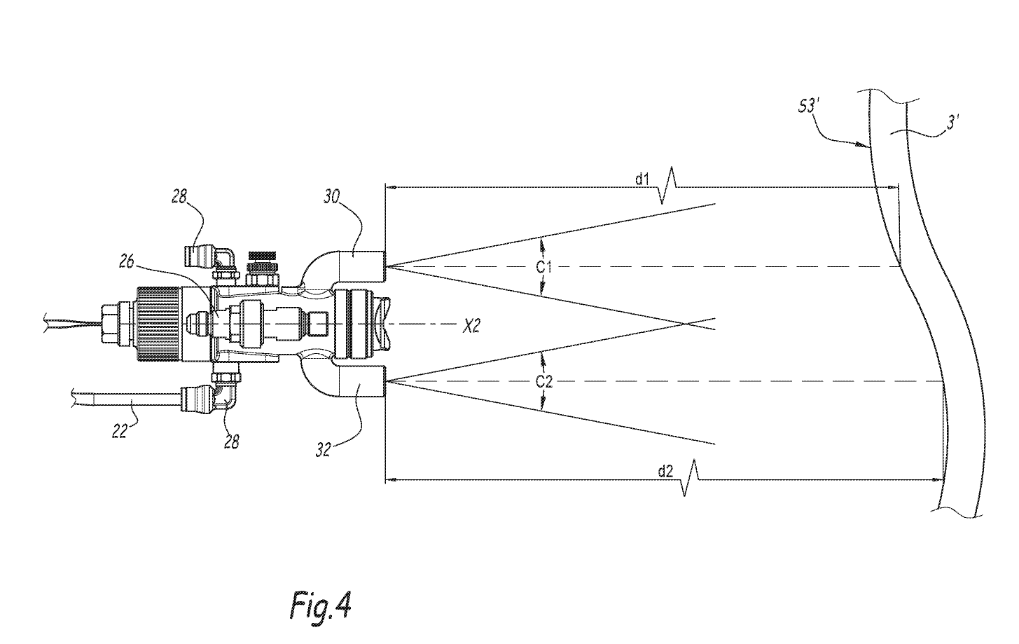

In theory, the operator 1 should hold the device 2 so as to keep the spraying axis substantially perpendicular to the surface to be coated. However, this may prove complicated when the surface to be painted is warped, like the surface S3′ of the object 3′ shown in FIG. 4. However, an inexperienced user may tend to tilt the spraying device 2 downward, upward, to his right or to his left. In this case, the spraying axis X2 is no longer perpendicular to the surface to be coated and the finishing quality risks being poor. Thus, the spraying device 2 advantageously comprises means for detecting a perpendicularity flaw between the spraying axis X2 and the surface to be coated.

In the example, the detection means comprise a member for measuring the orientation of the device 2 along one, two or three axes, in particular a gyroscope 38 (shown schematically in FIG. 2). Advantageously, the detection means also comprise the two ultrasonic sensors 30 and 32.

The gyroscope 38 is a unidirectional gyroscope, configured to measure the incline of the device around an axis, in particular around a horizontal axis Y0, which is perpendicular to the spraying axis X2 when the device 2 is held straight, i.e., in the configuration of FIG. 1, for example. The gyroscope 38 therefore makes it possible to evaluate the incline of the spraying axis X2 of the device 2 relative to the horizontal. The two ultrasonic sensors 30 and 32 in turn make it possible to detect any orientation flaw of the spraying device 2 around a vertical axis Z0, and therefore a perpendicularity flaw between the spraying axis X2 and the surface to be coated S3′. To that end, a computer (not shown) compares the distance values d1 and d2 measured by the sensors 30 and 32 (see FIG. 4). The deviation between the two values is representative of a perpendicularity flaw.

It is important to alert the user 1 when he is painting askew. The spraying device 2 therefore cleverly comprises an alarm system, designed to alert the user 1 when a perpendicularity flaw exists between the spraying axis X2 and the surface to be coated S3′. Advantageously, the alarm system can be triggered when the incline of the device 2 around the axis Y0 of the inertial frame of reference exceeds a threshold value, for example chosen to be equal to 5°, and when the deviation between the distances d1 and d2 exceeds a predefined percentage, for example equal to 10%.

The alarm system is preferably the same as that used to indicate an incorrect spraying distance. It is therefore also the vibrator 36. The triggering of the alarm system is controlled by a computer, in particular the same computer as that used to control the alarm system that is triggered to indicate an incorrect spraying distance.

In an alternative that is not shown, the means for measuring the spraying distance comprise, in place of the ultrasonic sensor(s), a distance sensor, such as an accelerometer coupled to a gyroscope, also called gyroscope-accelerometer. The gyroscope-accelerometer is integrated into the device 1 and makes it possible to measure the acceleration of the device 1 in at least one direction, for example in the direction parallel to the spraying axis X2. Advantageously, the accelerometer is a tri-axial accelerometer. A computer integrated into the device 1 is associated with the accelerometer to compute the movement of the device 1, from a starting point, along 1, 2 or 3 axes by double integration over time. The starting point is a point chosen arbitrarily on the surface to be coated, such as the point P0 shown in FIG. 1. Alternatively, the starting point can be a point chosen arbitrarily on a reference outside the part to be coated. In both cases, the operator conducts a calibration step before spraying. This step seeks to calibrate the accelerometer by positioning the device 1 as close as possible to the surface to be coated to set the starting point, and therefore to set the spraying distance at zero. For example, the device may comprise a button (not shown) allowing the user to calibrate the accelerometer. When the operator withdraws relative to the object to be coated, the processor computes the movement of the device in a direction X0 substantially perpendicular to the surface to be painted, which makes it possible to obtain, at each moment, the position of the device 1 relative to the object, and therefore a good approximation of the spraying distance. Advantageously, the accelerometer may be integrated into the gyroscope 38.

According to one particular example, the button allowing the user to calibrate the distance via the gyroscope-accelerometer is the control element 50. According to another alternative that is not shown, the device comprises other means for detecting a perpendicularity flaw. For example, the detection means may comprise any one of the following elements:
a three-dimensional gyroscope, or
a two-dimensional gyroscope, or
three ultrasonic sensors, or
at least two inclinometers, or
a one-dimensional gyroscope and an inclinometer.

In each case, the means used make it possible to evaluate a potential orientation flaw of the device 2 around at least two axes of an inertial frame of reference. The third axis pertaining to the rotation of the device around the spraying axis X2, a measurement of the incline of the device around this axis is not truly necessary.

A three-dimensional gyroscope measures the orientation of the spraying device 2 around three axes X0, Y0 and Z0 of a Cartesian inertial frame of reference. To that end, the gyroscope comprises its own frame of reference, defined by the axes X1, Y1 and Z1 perpendicular in pairs (moving Cartesian frame of reference) and gives the angular position of its frame of reference relative to the inertial frame of reference.

According to another alternative that is not shown, the spraying device 2 comprises an indicator system of the orientation of the device relative to an inertial frame of reference. The indicator system can be provided in the form of a display screen, providing a real-time display of the incline values of the device along one, two or three axes. The user can then correct any orientation flaw by viewing the display screen.

According to another embodiment, the indicator system is formed by several LEDs arranged perpendicular to the spraying axis, in particular aligned in a direction parallel to the axis Z1, so as to indicate the orientation of the device 2 around the axis Y1 relative to the surface to be coated. A single one of these LEDs is then illuminated, based on the orientation of the gun around the axis Y1 relative to the surface to be coated. When the LED in the middle of the row is illuminated, this means that the spraying axis X2 is globally perpendicular to the surface to be coated. Conversely, the other LEDs are illuminated when the user is aiming too high, or too low, relative to the shape of the surface to be coated. Comparably, a row of LEDs may also be provided in the direction parallel to the axis Y1, as an indicator system of the orientation of the device 2 around the axis Z1. The LEDs can also be arranged in an arc of circle.

The indicator system is therefore also configured to allow a user to estimate the orientation of the device 2, along one, two or three axes, relative to a minimum degree of orientation and a maximum degree of orientation. The minimum degree of orientation and the maximum degree of orientation are angles measured relative to the normal of the surface to be coated. Owing to this system, the user can situate himself relative to the orientation values not to be exceeded and thus orient the device 2 optimally, while trying to orient the device at the middle of the travel between the minimum degree of orientation and the maximum degree of orientation. When the device 2 is oriented optimally, i.e., when the degree of orientation is 0°, the spraying axis is perpendicular to the surface to be coated.

According to another alternative that is not shown, the electronic control unit of the closing system of the nozzle 34 is programmed to move the needle automatically into the closed position when the spraying distance is below a threshold boundary lower than or equal to the minimum value of 10 cm and/or when the spraying device is above a threshold boundary greater than or equal to the maximum value of 60 cm. Reference is then made to a safety zone comprised between 0 and 10 cm, which makes it possible to cut off the spraying device 2 when there is something in the field. This advantageously makes it possible to protect the user, by interrupting the spraying, when the latter places his hand in front of the nozzle, for example.

It is thus possible to consider first warning the user that the spraying distance is not correct and next to interrupt the spraying automatically if the spraying distance becomes truly critical (too close or too far). In this alternative, the means for measuring the spraying distance are connected to the electronic control unit so as to be able to send measuring information, in particular the value of the spraying distance.

According to another alternative that is not shown, the electronic control unit of the closing system of the nozzle 34 is programmed to move the needle automatically into the closed position when the incline angle of the device 2 around the axis Y0 is above a predetermined value, greater than or equal to the threshold value (5° in the example) and when the deviation between the values d1 and d2 exceeds a certain percentage, greater than or equal to 10%, for example. Thus, it is possible to consider first warning the user that the device 2 is oriented incorrectly, and then to interrupt the spraying automatically if the orientation of the device 2 becomes truly critical. In this alternative, the means for detecting a perpendicularity flaw are connected to the electronic control unit so as to be able to send measuring information, in particular the incline values.

According to another alternative that is not shown, the spraying device 2 is a semiautomatic device. The device 2 then simply comprises a safety element, provided to oppose the spraying of the coating product as long as the user is not holding the device in his hand. For example, this safety element can be a notch or a button, maneuverable between a locked position, in which it opposes the spraying of the coating product, and an unlocked position, in which the coating product can be sprayed automatically when an object is detected across from the device, i.e., in the spraying field of the device.

According to another alternative that is not shown, the “dead man” system is formed by a gripping sensor, capable of detecting when the spraying device 2 is held in a user's hand. This gripping sensor can be a capacitive sensor, an optical sensor or a thermal sensor. In the last case, the thermal sensor is integrated into the gripping stock 24 and detects the human warmth applied to the stock 24 when the user grasps the device 2. The gripping sensor is capable of sending a signal to the electronic control unit of the closing system of the nozzle 34 of the device 2. This signal is preferably of the binary type and then comprises two states: “0” when the device 2 is not being held, and “1” when the gripping sensor detects that the device 2 is being held. Thus, the “dead man” control element is configured to stop the spraying when the user releases the device 2, i.e., releases the stock 24.

According to another alternative that is not shown, the spraying device 2 comprises an indicator system, to inform the user of the spraying distance. This indicator system can be a display system, such as a screen, for providing a real-time display of the spraying distance. This screen can also display the minimum and maximum distance values to be respected during the coating of a part. The user then has all of the indications in view to spray the product at the correct distance.

Alternatively, the indicator system comprises several LEDs, for example 5 LEDs, aligned in the direction of the spraying axis. An LED is then illuminated based on the spraying distance. For example, the third LED (middle LED) can be illuminated when the user is approximately in the middle of the recommended distance range.

The indicator system is therefore configured to allow a user to estimate the spraying distance relative to the recommended minimum value and maximum value.

In all of the affected embodiments, the indicator system can be off board relative to the spraying device 2. For example, when the indicator system is a display screen, the latter can be installed against a wall of a spraying booth (not shown).

According to another alternative that is not shown, the alarm system comprises, in place of or in addition to the vibrator 36, a visual indicator, comprising at least one LED and/or a sound indicator, of the “beep” or “buzzer” type. The LED can be provided to blink with a higher frequency as the operator moves away from and/or closer to the distance range boundary or as the incline angle of the device relative to one of the axes of the inertial frame of reference increases. Likewise, the intensity and/or the frequency of the “beep” can be provided to increase as the operator moves further away from the correct distance range or the greater the perpendicularity flaw becomes. Additionally, the visual indicator may comprise several LEDs, for example three LEDs of different colors (1 green LED, 1 orange LED and 1 red LED), or a variable-color LED. Advantageously, the green color can be used to indicate that the perpendicularity is correct or that the user is in the correct distance range, the orange color can be used to indicate a slight perpendicularity flaw or that the user has reached the boundaries (lower and upper) of the recommended distance range, and the red color can be used to indicate a severe perpendicularity flaw or that the spraying distance is not comprised in the recommended distance range.

In all of the affected embodiments, the rows of LEDs can be formed by an RGB lighted display, comprising a strip of LEDs, an RGB controller and a specific light source.

According to another alternative that is not shown, the spraying device 2 comprises a speed sensor, such as an accelerometer, for estimating the speed at which the device is moved relative to a fixed frame of reference. In fact, the builders of manual spraying devices recommend sweeping speeds for the movement of the device relative to a surface to be coated. The accelerometer is provided to measure, by integration relative to time, the speed of the device in a direction perpendicular to the spraying axis (one-dimensional accelerometer), preferably along two or three directions perpendicular in pairs (two-dimensional or three-dimensional accelerometer). Advantageously, an alarm system as previously described (visual, sound and/or vibrational) is triggered when the operator moves the device 2 too quickly, i.e., at a speed above the speed recommended by the builder. The product spraying may also be interrupted. To that end, the electronic control unit of the closing system of the nozzle is connected to the speed sensor, to compare the speed value(s) measured by the sensor with a value prerecorded in memory, in accordance with builders' recommendations. Of course, this value is configurable.

According to another alternative that is not shown, the device 2 comprises a system for counting the number of opening and closing sequences of the nozzle 34, i.e., the number of times where the operator has pressed on the button 50 for a 100% manual sprayer. Advantageously, the device 2 may also comprise a means of communication with a computer system, for example with a computer. This means of communication may be a radio antenna, an RFID transceiver, an NFC chip, a Wi-Fi antenna, etc. Information relative to the number of opening and closing sequences of the nozzle 34 can then be sent to the computer system, which can in particular make it possible to estimate the wear of the sealing gaskets of the device 2 and schedule a preventive maintenance operation. This information can also be sent to the user via a display system, such as a screen, if the device is equipped with one. Additionally, the device 2 can send the computer system, instantaneously or on a deferred basis, information relative to the spraying times. Based on this information and the coating product flow rate of the device 2, the system can then calculate the quantity of sprayed coating product and the quantity of coating product remaining in the supply housing 7.

According to another alternative that is not shown, the alarm system is separate from the spraying device 2 and is off board relative thereto. It may for example be formed by a “buzzer” or a related beacon arranged inside the spraying booth. In this case, the computer on board the spraying device 2 communicates with the alarm system via a wireless transmission system (radio, Wi-Fi, etc.).

Furthermore, in the example of the figures, the means for measuring the spraying distance and the means for detecting a perpendicularity flaw are integrated into the gun during manufacturing. In an alternative that is not shown, these means may be integrated into the alarm system, which would be removable relative to the gun. The alarm system would then assume the form of an accessory that would be connected selectively on a port of the gun.

The features of the embodiment described above and the various alternatives that are not shown may be combined to create new embodiments of the alarm system, and consequently the assembly.

The spraying device 2 makes it possible to carry out a pneumatic spraying method according to the invention.

The ultrasonic sensors 30 and 32 are proximity sensors, which each have a detection cone C1 and C2, respectively. The sensors 30 and 32 are positioned such that the detection field of one is partially contained in the detection field of the other. This means that there is an overlap area, i.e., an area covered by both sensors at the same time. In the example, the sensors 30 and 32 are ultrasonic sensors, such that their detection field is formed by a cone, which is why reference is made to a detection cone.

The spraying device 2 comprises a system for injecting a coating product and a system for injecting spraying air, in particular comprising the air intakes 22 and closing valves for the conduits 22 (not shown). The product injection system advantageously comprises the nozzle 34 and a closing needle of the nozzle (not shown).

The spraying air makes it possible to spray the product in spray form, i.e., in fine droplets. This is the principle of pneumatic spraying.

When the user moves the device 2 horizontally from left to right, the sensor 32 begins to detect the presence of an object 3′ in its detection field. This presence detection drives the opening of the spraying air injection system: the valves of the system open and the device 2 blows air. The object 3′ is next detected by the sensor 30, which drives the opening of the product injection system. A time delay is thus produced between the opening of the air injection system and the opening of the product injection system. This time delay makes it possible to avoid the transitional period during which the product jet is not stabilized.

When the user reaches the end of the object 3′, the latter leaves the detection field of the sensor 32, but nevertheless remains in the detection field of the sensor 30. This causes the product injection system to close. The device 2, however, continues to blow air. The object 3′ next leaves the detection field of the sensor 30, which drives the closing of the air injection system. A time delay therefore occurs between the closing of the product injection system and the closing of the air injection system. This time delay makes it possible to save on the quantity of coating product used when the product is sprayed on the chain of the parts conveyed along a production line and also when roundtrips are made on a same part or when the coating is applied on a part with openings.

In practice, the sensors 30 and 32 send signals to an electronic control unit, able to command the opening and closing of the product injection system and the air injection system. These signals are advantageously of the analog and/or digital type.

In the example of the figures, the device 2 comprises two proximity sensors offset relative to one another in a horizontal plane and along an axis perpendicular to the spraying axis when the device 2 is held in one's hand. However, in an alternative that is not shown, the two sensors could be offset in a perpendicular manner, i.e., along a vertical axis when the device 2 is held in one's hand.

Additionally, the two sensors 30 and 32 could be integrated with one another. A first of the two sensors comprises a broader detection field than the second sensor. For example, the detection cone of the first sensor may have a half-angle of 30°, while the detection cone of the second sensor may have a half-angle of 20°. In this configuration, the detection field of the second sensor is completely contained in the detection field of the first sensor.

In this embodiment, the air injection system opens when an object enters the detection field of the first sensor, i.e., the sensor with the widest detection field. The product injection system subsequently opens when the object enters the detection field of the second sensor. The product injection system closes when the object leaves the detection field of the second sensor and the air injection system closes when the object leaves the detection field of the other sensor.

According to another alternative that is not shown, the spraying device 2 comprises a single proximity sensor, for example any one of the sensors 30 and 32. In this embodiment, the air injection system opens when an object enters the detection field of the sensor and the product injection system opens on a time delay relative to the air injection system. Likewise, the product injection system closes when the object leaves the detection field of the sensor and the air injection system closes on a time delay relative to the product injection system.

According to another alternative that is not shown, the spraying device 2 comprises a means for electrostatically charging the coating product, which is activated before or during the opening of the air injection system and which is deactivated during or after the closing of the air injection system. Preferably, the means for electrostatically charging the coating product is activated manually, for example during the maneuvering of the control element 50 of the spraying device 2.

The features of the embodiment described above and the various alternatives that are not shown may be combined to create new embodiments of the method.

1. An alarm system, designed to send an alarm signal to a user equipped with a spraying device when a spraying distance is below a minimum value or above a maximum value and/or when a perpendicularity defect exists between a spraying axis of the spraying device and a surface to be coated facing the spraying device, the alarm system comprising at least one measuring means for measuring a spraying distance with the surface to be coated facing the spraying device and/or detection means for detecting a perpendicularity defect between the spraying axis and the surface to be coated.

2. The alarm system according to claim 1, comprising a visual element and/or a sound element and/or a vibrator.

3. The alarm system according to claim 1, the alarm system being off board relative to the spraying device.

4. The alarm system according to claim 1, the measuring means comprising at least one ultrasonic sensor or a movement sensor.

5. The alarm system according to claim 1, the detection means comprising any one of the following elements:
a three-dimensional gyroscope, or
a two-dimensional gyroscope, or
three ultrasonic sensors, or
at least two inclinometers, or
a one-dimensional gyroscope and an inclinometer, or
a one-dimensional gyroscope and two ultrasonic sensors.

6. An assembly comprising an alarm system according to claim 1 and a spraying device.

7. The assembly according to claim 6, wherein the alarm system is on board the spraying device.

8. The assembly according to claim 6, wherein the spraying device comprises a speed sensor for estimating the speed at which the device is moved relative to an inertial frame of reference.

9. The assembly according to claim 6, wherein the spraying device is configured to spray only when the user exerts a particular action on the spraying device, which is different from that of pulling a trigger.

10. The assembly according to claim 6, wherein the spraying device is configured to spray only when the spraying distance is between a minimum and maximum value and/or only when the angle between the spraying axis of the spraying device and the surface to be coated facing the spraying device is between a minimum and a maximum value.

11. The assembly according to claim 6, wherein the assembly also comprises a system indicating the spraying distance and/or a system indicating the orientation of the spraying device relative to an inertial frame of reference, to allow a user to estimate the spraying distance relative to the minimum value and relative to the maximum value and/or to estimate the orientation of the spraying device relative to a minimum degree of orientation and a maximum degree of orientation.

12. The assembly according to claim 11, wherein the indicator system is on board the spraying device or offboard relative to the spraying device.

13. The assembly according to claim 6, wherein the spraying device is a device with no actuating trigger.

14. The assembly according to claim 6, wherein the spraying device comprises a means of communication with a computer system, capable of sending said computer system, instantaneously or on a deferred basis, information relative to the spraying.

15. A pneumatic spraying method, implemented using a spraying device comprising:
a proximity sensor, capable of detecting the presence of an object in the detection field,
a product injection system for injecting a coating product,
an air injection system for injecting spray air,
wherein the method comprises the following automated steps, during which:
a) the air injection system opens when an object enters the detection field of the proximity sensor,
b) the product injection system opens on a timer relative to the air injection system,
c) the product injection system closes when the object leaves the detection field of the proximity sensor,
d) the air injection system closes on a timer relative to the product injection system.

16. The method according to claim 15, wherein the spraying device comprises a means for electrostatically charging the coating product, which is activated before or during step a) and which is deactivated during or after step d).

17. The method according to claim 16, wherein the means for electrostatically charging the coating product is activated manually.

18. A pneumatic spraying method, implemented using a spraying device comprising:
two proximity sensors, positioned such that the detection field of one is at least partially contained in the detection field of the other,
a product injection system for injecting a coating product,
an air injection system for injecting spray air,
wherein the method comprises the following automated steps, during which:
a) the air injection system opens when an object enters the detection field of either one of the two proximity sensors,
b) the product injection system opens when the object enters the detection field of the other proximity sensor,
c) the product injection system closes when the object leaves the detection field of either one of the two proximity sensors,
d) the air injection system closes when the object leaves the detection field of the other proximity sensor.

19. The method according to claim 18, wherein the spraying device comprises a means for electrostatically charging the coating product, which is activated before or during step a) and which is deactivated during or after step d).

20. The method according to claim 19, wherein the means for electrostatically charging the coating product is activated manually.
